(19) United States
(12) Patent Application Publication
(10) Pub. No.: US 2010/0043700 A1
(43) Pub. Date: Feb. 25, 2010

(54) CURTAIN COATER

(76) Inventor: Michael Trefz, Heidenheim (DE)

Correspondence Address: TAYLOR & AUST, P.C., P.O. Box 560, 142. S Main Street, Avilla, IN, 46710, US

(21) Appl. No.: 12/535,223

(22) Filed: Aug. 4, 2009

(30) Foreign Application Priority Data
Aug. 21, 2008 (DE) DE 102008041418.2

(51) Int. Cl. B05C 5/00; B05C 9/12

(52) U.S. Cl. 118/68

(57) ABSTRACT

A machine including at least one curtain applicator device which coats onto one application segment of the material web path further includes a segment in the web path immediately following a turning arrangement of the coating application segment which directs the material web downward which is a drying section where the material web passes through at least one non-contact drying device which subjects the coating medium to the effects of heat. Alternatively or in addition, the material web after turning of its path and/or at the end of the coating application segment is supplied to the drying device of a drying section in such a way that the heat effect of the drying device upon the coating medium begins at a lower level relative to the coating application segment.

### BACKGROUND OF THE INVENTION

1. Field of the Invention

The present invention relates to a machine for the application of a liquid or paste-like coating medium onto at least one surface of a moving material web, especially a paper or cardboard web, by way of at least one curtain applicator device, and drying of the applied coating medium by way of at least one non-contact drying device; whereby the material web passes several turning arrangements in the machine which are in contact with the web and which define material web segments which are offset relative to each other and/or progress in different directions; whereby the curtain applicator device delivers the coating medium from at least one delivery opening, especially a slot die or a slide die in the form of a single- or multi-layer curtain under the influence of gravity and possibly the influence of other forces onto the allocated surface of the web in one coating application segment of the material web path which progresses essentially horizontally or according to a radius of a turning or support roll in the curtain applicator device or which has at least a greater moving velocity component in horizontal direction than in vertical direction; whereby the material web in at least one drying segment following the coating application segment in the web path passes the, or at least one, non-contact drying arrangement which subjects the coating medium to a heat effect in order to dry the applied coating medium at least partially; and whereby the material during its progression and/or at the end of the coating application segment is turned around at least one turn angle by a first turning arrangement—if provided—including the turn and support roll, so that the material web in at least one first path segment immediately following the redirection after the turn then progresses essentially vertically downward, at least initially, or has a greater moving velocity component in vertical direction downward than prior to the turn.

2. Description of the Related Art

Curtain applicator devices of this type, also known as “curtain coaters” are known in various embodiments and have gained significance for coating of paper and cardboard over the last few years.

In coating of paper and cardboard the drying of the coating layer initially occurs contactless so that the still moist surface is not damaged. This applies independent of the application process.

In the non-contact drying section the water is heated and evaporated as a rule by infrared radiators or hot air dryers. It is generally known that the drying should begin as quickly after coating as possible. This prevents the soluble components from migrating from the liquid coating ink into the paper, that is into its network of fibers, or respectively this migration is being limited. The liquid components of the coating ink are to remain in the filler matrix of the coating ink, generally the coating medium, since they facilitate a good quality during later printing.

Attempts have therefore been made to construct lines which are utilized for coating so that the drying begins in the shortest possible distance from the coating unit. FIG. 8 shows several examples of current coating methods, namely blade or doctor coating (detail FIGS. 8a and 8b) and film coating (FIG. 8c). In such contact coating methods the first drying element is generally located already after only one web turn. The distance between coating application and beginning of drying is generally between 2 and 8 meters.

In the last few years a new application method—curtain coating—has gained significance with the “curtain coater”. There are several production lines, such as pilot lines. When utilizing a falling curtain or veil a certain configuration of the nozzle delivering the coating ink, generally the coating medium, onto the material web (especially paper or cardboard web) is predefined due to the gravity. At the moment of coating application the material web must essentially progress horizontally. Subsequently the coated side cannot be touched. This results in limitations for the subsequent arrangement of a drying section. Typical arrangements from the state of the art are illustrated in FIG. 7. The web has to undergo several directional changes before it reaches a top mounted drying section. The distance from the point of the coating application to the beginning of the drying is therefore clearly longer than with other coating methods. This is a disadvantage and may especially present disadvantages with regard to the print quality and is also associated with greater mechanical expenditure due to the utilization of a relatively large number of guide or turn rollers.

What is needed in the art is to locate a drying section following a curtain applicator device (curtain coater) relative to the curtain applicator device so that a comparatively short distance between the location of the coating application (the coating application segment) and the beginning of the drying (the drying section) is realized.

### SUMMARY OF THE INVENTION

The present invention provides a machine for the application of a liquid or paste-like coating medium onto at least one surface of a moving material web, especially a paper or cardboard web, by way of at least one curtain applicator device, and drying of the applied coating medium by way of at least one non-contact drying device; whereby the material web passes several turning arrangements in the machine which are in contact with the web and which define material web segments which are offset relative to each other and/or progress in different directions; whereby the curtain applicator device delivers the coating medium from at least one delivery opening, especially a slot die or a slide die in the form of a single- or multi-layer curtain under the influence of gravity and possibly the influence of other forces onto the allocated surface of the web in one coating application segment of the material web path which progresses essentially horizontally or according to a radius of a turning or support roll in the curtain applicator device or which has at least a greater moving velocity component in horizontal direction than in vertical direction; whereby the material web in at least one drying segment following the coating application segment in the web path passes the, or at least one, non-contact drying arrangement which subjects the coating medium to a heat effect in order to dry the applied coating medium at least partially; and whereby the material during its progression and/or at the end of the coating application segment is turned around at least one turn angle by a first turning arrangement—if provided—including the turn and support roll, so that the material web in at least one first path segment immediately following the redirection after the turn then progresses essentially vertically downward, at least initially, or has a greater moving velocity component in vertical direction downward than prior to the turn.

According to the invention, the first segment of the material web path immediately following the turn in direction of progression and/or at the end of the coating segment is a drying section where the material web passes through at least one non-contact drying arrangement which subjects the coating medium to the effects of heat. Surprisingly it has been found that the first segment of the material web path following immediately after the first turn arrangement is well suited for the location of at least one drying element, so that this segment of the web path which is referred to as “first segment” can therefore serve as drying segment or drying section.

In the current application consideration has been given particularly with respect to the term “segment of the material web path” in other words “coating segment”, first segment” and with regard to possible further advancements which will be discussed below, also “second segment” and “third segment” of the material web path so that this segment on the infeed and outfeed side respectively is defined by a turning arrangement which contacts the material web. If a turn- and support roll is utilized and allocated to an applicator head of a curtain applicator device, then this turn- and support roll (support- and turn roll) alone can define the coating application segment and provide it with a curved progression.

A non-contact turn arrangement in this preferred definition does not limit a segment of the material web path and can accordingly be located for example in the middle of such a “segment of the material web path”.

On the basis of this definition a non-contact turn arrangement can sub-divide such a segment of the material web path that is limited on the infeed and outfeed by contact turning arrangements, into “partial segments” of the material web path, namely into a partial segment between the infeed side contact turn arrangement and the non-contact turn arrangement, and into a partial segment between the non-contact turn arrangement and the outfeed side contact turn arrangement. It is however also conceivable that a substantial partial segment of such a material web path progresses along or through a non-contact turning arrangement so that this partial segment represents the greatest part of the entire segment.

In order to solve the addressed need for the machine identified at the beginning, it is suggested according to the invention that alternatively, or in addition, the material web after turning of its path and/or at the end of the coating application segment is supplied to the/one drying device of the/one drying section which subjects the coating medium to the effect of heat in such a way that the heat effect of the drying device upon the coating medium begins at a lower level relative to the coating application segment.

Most of the embodiments under consideration will be consistent with both inventive suggestions and to that extent can be considered as alternative definitions of the same technical theory. Individual inventive design variations however may also correspond to only one of these inventive definitions.

Regarding the inventive suggestions one primarily considers that in the drying segment or respectively after the turning by the first turning arrangement and—in the case of an additional turn of the material web in the direction of travel of the web prior to this additional turning—the material web passes through the, or the at least one, non-contact drying device which subjects the drying medium to the effects of heat, essentially vertically downward, or with a greater moving velocity component in vertical downward direction than prior to the turn.

Especially preferred is an embodiment of the machine where the material web progresses vertically downward in the first segment of the material web path, at least initially, following immediately after the first turning arrangement, or has a greater moving velocity component in a downward vertical direction than in horizontal direction.

It is preferred that in the drying segment or respectively after turning by the first turning arrangement and—in the case of an additional turn in the direction of travel of the material web prior to this additional re-directing—the material web passes essentially vertically downward or with a greater moving velocity component in a downward vertical direction than in horizontal direction through the, or at least through one, non-contact drying device which subjects the coating medium to the effects of heat.

Preferably therefore, that segment or respectively partial segment of the material web path after the turning arrangement at the end of the coating application segment is utilized as a drying section in which the material web moves downward and is not yet subjected to additional turning.

In a further advancement it is suggested that the material web in the drying segment, or respectively in the first segment of the material web path immediately following after the first turning arrangement, and/or in a second segment of the material web path following a second turning arrangement passes a non-contact turning arrangement which turns the material web by at least a turning angle in a manner that the material web in a material web outfeed area of the non-contact turning arrangement progresses essentially vertically in an upward direction or has a greater moving velocity component in vertical upward direction than before the turning by the non-contact turning arrangement, or has a greater moving velocity component in vertical upward direction than in horizontal direction. The first segment of the web path can therefore extend along the non-contact turning arrangement, or extend beyond it. Alternatively or in addition it is also possible that the, or one additional non-contact turning arrangement is located in a second segment, following after the first segment in the material web path. Here, one considers primarily that the second turning arrangement is located adjacent to an infeed of the non-contact turning arrangement and turns the material web in such a way that the after the turn through the second turning arrangement the material web initially essentially progresses vertically downward or initially has a greater moving velocity component in a vertical downward direction than before the turn by the second turning arrangement, or initially has a greater moving velocity component in a vertical downward direction than in horizontal direction.

With regard to the non-contact turning arrangement an especially preferred embodiment is suggested, whereby it is in the embodiment of a non-contact drying device which subjects the coating medium to the effects of heat or at least includes a non-contact drying device which subjects the coating medium to the effects of heat, so that the applied coating medium can be subjected to the effects of drying during turning. A “turning section” that is defined by the turning arrangement can therefore serve as a drying section. This may be the first drying section after the curtain application or an additional drying section, for example a second drying section after the curtain application.

An especially preferred arrangement provides that the drying section provided by the turning arrangement or respectively by the at least one drying device represents a major part of the first segment of the material web path, which is turned by the non-contact turning arrangement by more than 90°, most especially preferred by approximately 180° and can then advantageously pass through an additional turning arrangement.

In a further advancement it is suggested that the material web after being turned by the non-contact turning arrangement passes through the, or at least through one, non-contact drying device which subjects the coating medium to the effects of heat, essentially vertically upward, or has at least a greater moving velocity component in a vertical upward direction than before the turn by the non-contact turning arrangement, or respectively has at least a greater moving velocity component in vertically upward direction than in horizontal direction.

Another option is that the material web after being turned by the non-contact turning arrangement and passing through a third turning arrangement in a following third segment of the material web path passes through at least one non-contact drying device which subjects the coating medium to the effects of heat. The third turning arrangement may be advantageously located adjacent to an outfeed of the non-contact turning arrangement and turns the material web in such a way that after turning by the third turning arrangement the material web progresses essentially vertically upward, or has a greater moving velocity component in a vertical upward direction than before being turned by the third turning arrangement, or has a greater moving velocity component in a vertical upward direction than in horizontal direction.

The drying section realized by the arrangement of the drying device that is located after the non-contact turning arrangement or respectively the third turning arrangement may be the first or an additional, for example a second or third drying section after the curtain application.

An advantageous embodiment may provide that segments or partial segments of the material web path before and after the non-contact turning arrangement provide an essentially parallel path of the material web.

A turn realized by a respective contact or non-contact turning arrangement may be single- or multi-level, in other words may occur in one turn angle or in several turn angles which together complete a total turn angle. It is especially also conceivable that the first turning arrangement includes a first turn roller or several first turn rollers by way of which the material web is turned around a first turn angle, or respectively around several turn angles in order to achieve a first complete turn angle and/or that the second turning arrangement includes one turn roller or several turn rollers by way of which the material web is turned around a second turn angle, or respectively around several turn angles in order to achieve a second complete turn angle, and/or that the third turning arrangement includes a third turn roller or several third turning rollers, by way of which the material web is turned around a third turn angle, or respectively around several turn angles in order to achieve a third complete turn angle.

The machine may also include several curtain applicator devices through which the material web passes. Here it is specifically suggested that the material web in its direction of travel either before the at least one curtain applicator device, or after it passes through at least one additional curtain applicator device which delivers the coating medium from at least one delivery opening, especially from a slot die or a slide die in the form of a single- or multi-layer curtain under the influence of gravity and possibly under the influence of other forces onto the allocated, same or preferably other surface of the material web in an additional coating application segment of the material web path. The additional coating application segment progresses essentially horizontally or curved according to a radius of a turn- or support roll of the curtain applicator device, or has at least a greater moving velocity in horizontal direction than in vertical direction, whereby the material web in at least one additional drying segment that is located following the at least one additional coating application segment passes at least through one non-contact drying device which subjects the coating medium to the effects of heat in order to dry the applied coating medium at least partially; and whereby the material web in its progression and/or at the end of the additional coating application segment is turned around at least one turn angle by an additional first turning arrangement, so that after the turn the material web progresses vertically downward, at least initially, in at least one first additional segment of the web path immediately following this turn, or has a greater moving velocity component in vertical downward direction than prior to the turn. Therefore, a multi-step medium application can be made onto the same material web surface, or a separate application can be made onto both surfaces (front side and back side) of the material web.

In a multi-layer application, the utilized coating medium may be of the same type, however preferably of various types, for example starch, coating ink, etc.

The invention can be realized with its suggestions of further advancement also with regard to the at least one additional curtain applicator device. According to the invention it is therefore suggested that the additional first segment of the material web path immediately after the turn in the web path and/or at the end of the additional coating application segment represents an additional drying segment in which the material web passes through the, or through at least one, additional non-contact drying device which subjects the coating medium to the effects of heat. Alternatively, or in addition, it is suggested that, after the turn in the web path and/or at the end of the additional coating application segment the material web is supplied to an additional drying device of an additional drying segment which subjects the coating medium to the effects of heat in such a way, that the heat effect of the additional drying device upon the coating medium begins at a lower level relative to the additional coating application segment.

It is preferred that, after the turn in the web path and/or at the end of the additional coating application segment, especially in the additional first segment, and if desired in an additional second segment following the latter and/or an additional third segment in the web path, the material web path is consistent with the inventive theory and the above cited suggestions for further advancements.

General thinking is that segments or partial segments of the material web path, after the coating application segment, and after the additional coating application segment provide moving velocity components of the material web in opposite horizontal directions relative to each other. Here it can advantageously be provided that segments or partial segments in the web path, after the coating application segment and after the additional coating application segment provide an essentially parallel path of the material web with moving velocity components of the material web in opposite horizontal directions relative to each other.

Generally it is suggested to locate the beginning of the drying section as closely to the point of the coating medium application (ink-application) as possible. For this purpose the web is re-directed downward after the curtain application. The start of the drying is then advantageously located lower than the point of impact of the coating medium. During the progression of the single- or multi-step drying the material web is then preferably turned by at least approximately 90° and preferably by approximately 180°.

Characteristics or elements of an inventive design form can advantageously be as follows:
At least one applicator device to apply liquid coating medium;
The applicator device is a so-called curtain coater;
The curtain applicator device includes at least one slot die or one slide die to deliver the coating medium;
The applicator device can be in the embodiment of a double-die, twin die, tandem die;
The applicator device applies the coating medium in at least one layer, for example onto the top side of the material web;
The material web is re-directed from the horizontal direction in a downward direction;
The drying section starts immediately following this re-direction;
The start of the drying section is lower than the point of the coating medium application;
A distance between the coating medium application (ink application) and the beginning of the drying is between 2 meters and 8 meters along the material web path;
The drying occurs by way of infrared radiation and/or by way of hot air treatment;
The drying section can consist of several individual dryers;
The coated material web side does not contact any contact turn element, especially no turn rollers, before the drying process is completed;
The drying can occur in dryers through which the material web passes in a straight line and/or passes through in a curved radius;
During the course of the single- or multi-step drying, the material web undergoes a directional change of at least 90°.

Not all of these characteristics or elements need be included in one inventive solution

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an example of a first design variation for a curtain applicator device (so-called “curtain coater”) for coating a paper or cardboard web, with a dryer immediately following the applicator device;

FIG. 2 shows a second example of a design variation for a curtain applicator device (so-called “curtain coater”) for coating a paper or cardboard web, with a dryer immediately following the applicator device;

FIG. 3 shows a third example of a design variation for a curtain applicator device (so-called “curtain coater”) for coating a paper or cardboard web, with a dryer following the applicator device immediately after a non-contact turn;

FIG. 4 shows a fourth design example of a design variation for two curtain applicator devices, located in tandem along the path of the paper or cardboard web, for two-sided coating, with the respective dryer located immediately after the respective curtain applicator device;

FIG. 5 shows a fifth example of a design variation for a curtain applicator device (so-called “curtain coater”) for coating a paper or cardboard web with a dryer located immediately following the applicator device, whereby the dryer in the embodiment of a hot air dryer provides for a curved material web path, thereby fulfilling a material web turning function;

FIG. 6 shows a sixth example of a design variation for a curtain applicator device (a so-called curtain coater) for coating a paper or cardboard web with a dryer located immediately following the applicator device, similar to FIG. 5, however with hot air treatment on both sides of the material web;

FIG. 7 shows typical examples of conventional arrangements of a curtain applicator device with a dryer located after them; and

FIG. 8 shows typical examples of conventional arrangements of a contact type coating unit with a dryer located after it.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

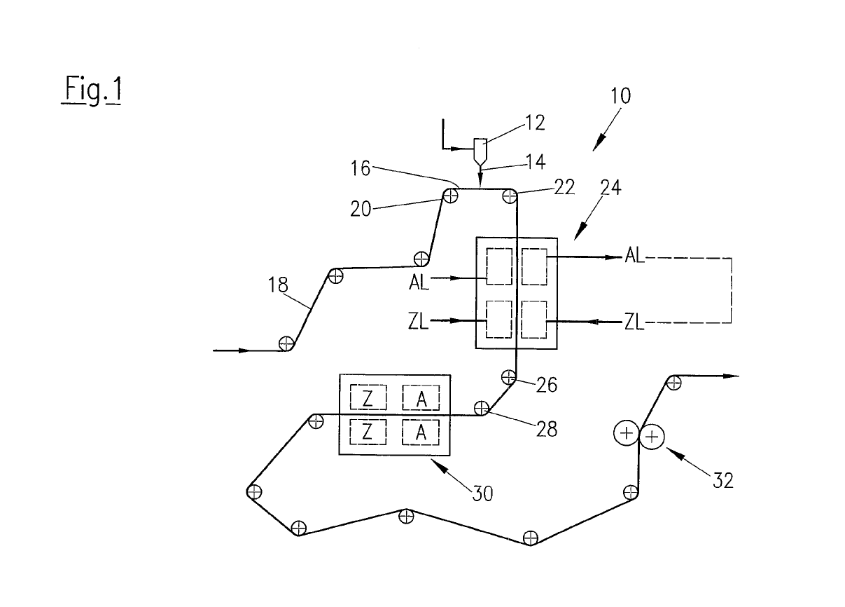

Referring now to the drawings, and more particularly to FIG. 1, there is shown an example of a curtain applicator device 10 (a so-called “curtain coater”, also often abbreviated with CC) which includes a curtain applicator head 12 which is supplied with a liquid coating medium, for example coating ink, which is applied under the influence of gravity is applied in the form of a downward moving curtain or veil 14 onto a preferably at least approximate horizontally extending coating application segment 16 of the material web 18. The material web is pulled through the applicator device, especially the coating unit, by way of a pulling group 32.

In the design example the material web 18 is supplied to the applicator device over several turn rollers, whereby the turn rollers 20 and 22 define the coating application segment 16. The material web, especially a paper or cardboard web, is turned in a downward direction by the turn roller 22 and enters a first dryer 24 immediately afterwards. The dryer in the example is a hot air dryer which blows hot air at least onto the surface carrying the coating medium, and preferably onto both sides of the material web. The dryer can be configured so that the blow nozzles and suction zones alternate and a recirculating air operation is realized whereby water-laden air between hot air nozzles (exhaust air AL or A) is sucked off and is blown back again as additional air (ZL or Z) onto the web.

According to the design example drying of the web—after an additional turn of the web by two turn rollers 26 and 28—is completed in an additional hot air dryer 30 which can also operate on the recirculating air principle. Until drying completion the coated side of the web is not touched by turn cylinders or turn rollers. By way of additional turn rollers and the pulling group 32, the material web is then supplied to further processing or conversion units, for example to an additional coating unit which applies coating to the same or to the opposite side of the material web.

One or both dryers can also be in the embodiment of infrared radiation dryers.

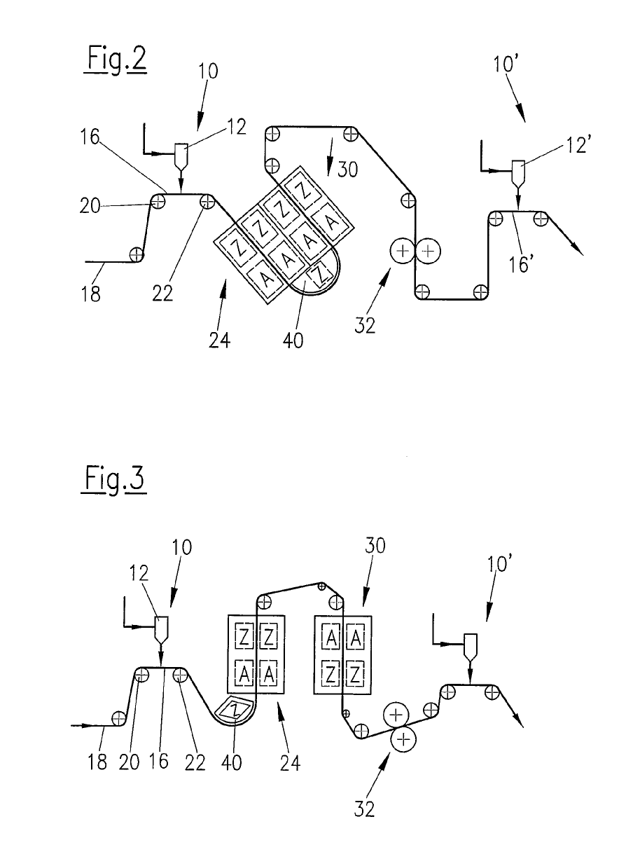

Again, in the second design example according to FIG. 2 the top side of the material web, especially the paper web is coated by a curtain applicator device 10 which includes the curtain applicator head 12, which applies coating onto the coating application segment of the material web 18. The material web is then turned downward slanting by the turn roller 22 and immediately enters a first dryer, especially a hot air dryer 24. After passing through the dryer 24 the web, along its coated side, is turned by approximately 180° by way of a non-contact turn arrangement, for example a so-called air-turn (AT) 40. The air-turn 40 does not damage the surface of the web which is still moist from the coating, since the web is supported on an air cushion while being turned. After turning, drying of the web is then completed in an additional dryer, especially a hot air dryer 30, which is located following the air-turn 40. Until drying is completed the coated side of the web is not touched by turn cylinders or turn rollers. A pulling group 32 pulls the web through the machine. According to FIG. 2 a pulling group 32 pulls the material web 18 in to a second curtain applicator device with an applicator head 12′ which—in the coating application segment 16′—provides another application onto the same material web side as the curtain applicator device 10. In order to apply a coating on the other side of the material web, a device for turning over the web could be located between the pulling group 32 and the applicator device 10′.

FIG. 3 illustrates a third design example which has similarities with that shown in FIG. 2. The curtain applicator head 12 of the curtain applicator device 10 also applies a coating application onto the essentially horizontally progressing coating application segment 16 of the material web 18, and the material web is subsequently re-directed downward slanting by the turn roller 22. The dryer, especially the hot air dryer 24, is however located after a non-contact turning arrangement, especially an air-turn 40, which re-directs the web along its coated side in an upward direction, so that, for example, an almost vertical material web path results. After this turn the material web enters the first dryer, especially the hot air dryer 24. After contact turning by way of several turn rollers by approximately 180° the material web then runs through the second dryer, especially a hot air dryer 30 in an almost vertically downward progressing segment, where the drying of the web is completed. The coated side of the material web is not touched by rolls and other contacting turn elements until drying of the web is completed. After drying is completed in the dryer 30, a further turn in an upward direction occurs before the web reaches the pulling group 32, which pulls the web through the machine, after which the material web can then be supplied to a second curtain applicator device 10′.

In the example in FIG. 2 as well as in that in FIG. 3 the arrangement of dryers following the second applicator device 10′ can be consistent with the arrangement of dryers following the respective first applicator device 10.

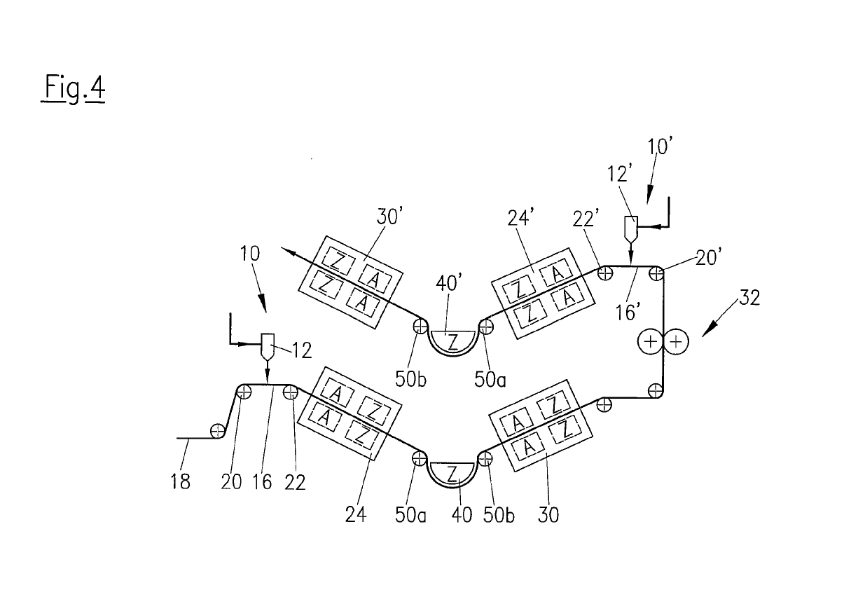

FIG. 4 illustrates a fourth design example which shows a two-sided curtain coating application onto the material web 18. The curtain applicator device 10 applies coating onto the top side of the material web, especially paper web, in the coating application segment 16. The material web is turned in a downward slanting direction by the turn roller 22 and runs through the dryer, especially the hot air dryer 24. Subsequently the web is turned in an upward slanting direction along the still moist top side by way of the air-turn 40, whereby on the infeed side and the outfeed side of the air-turn 40 respectively a turn roller 50a causing a stronger downward turn and respectively a turn roller 50b causing a return to a slanted progression can be located.

After the turn the drying of the web is completed by a second dryer, especially a hot air dryer 30 which is located in an upward slanting web segment. The web tension is maintained by the pulling group 32. Turn rollers located before and after the pulling group turn the web by more than 90°, preferably by 180° so that the web alters its direction of travel and subsequently in the coating application segment 16′ the bottom side of the material web is coated by way of the curtain applicator head 12′ of the curtain applicator device 10′. This coating application segment of the material web is defined by the appropriate turn rollers 20′ and 22′. The turn roller 22′ directs the material web downward slanting. Then follows an arrangement consistent with the first coating arrangement, consisting of a first dryer 24′ and a second dryer 30′. Turning devices are located between them, namely the air-turn 40′ with an upstream turn roller 50a and a downstream turn roller 50b. The drying of the bottom side therefore, occurs in a geometric arrangement, analogically to the drying of the top side.

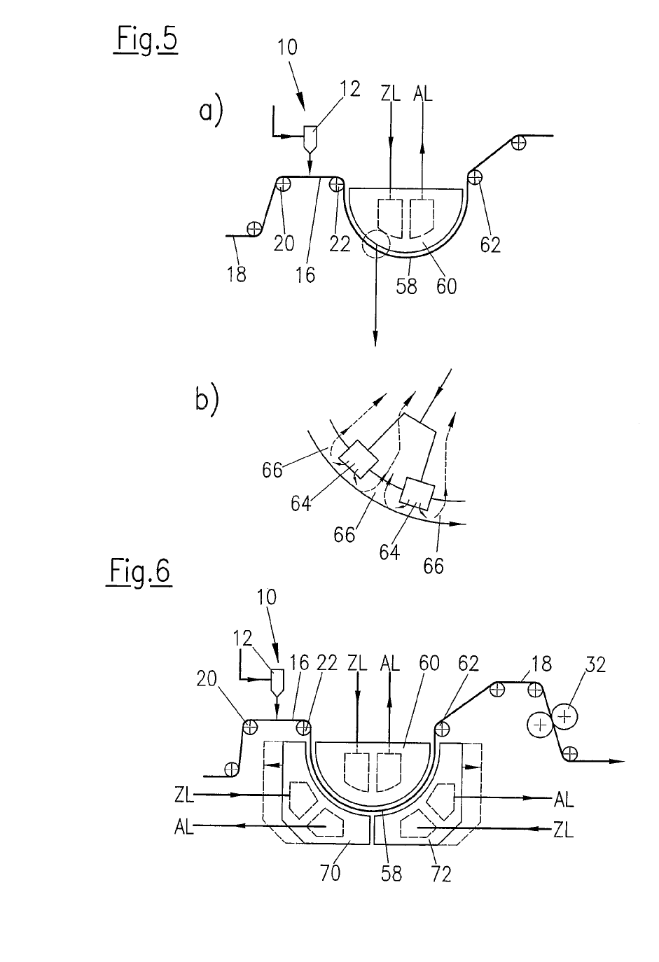

FIG. 5 illustrates a fifth design example whereby the material web segment 58 which follows the coating application segment 16 and which is defined by the turn rollers 22 and 62 represents a turn segment and at the same time a drying segment whereby, on the one hand, the material web is turned by the hot air dryer 60 which functions as a non-contact turning device by more than 90°, in the case of the example by approximately 190° in an upward direction and, on the other hand, is dried during this turn by the hot air treatment on the coated side of the web. After the turn of the material web 18 by the turning roll 22 the web immediately enters the area of influence of the turning- and drying device 60. This is a dryer providing one-sided heating which treats only the coated side of the web with hot air. The web path in the dryer, or respectively along the dryer, is curved in a radius R.

It is generally suggested that the web is turned by at least 90°, preferably by more than 90°, and most especially preferred—as shown in the design example—by approximately 180°. The dryer 60 may be configured so that blowing nozzles and suction zones alternate along the curved contour, as indicated in a detailed section FIG. 5(b) of the drawing FIG. 5(a). Here, the blow nozzles are identified with 64 and the suction zones between them with 66. The blow nozzles blow hot air onto the web. The water laden air is sucked off between the nozzles, so that the dryer can operate advantageously according to the recirculating air principle.

The design example shown in FIG. 6 differs from the design example in FIG. 5 essentially in that the material web 18 is dried from both sides. In addition to the dryer 60, the hot air drying arrangement therefore includes also a dryer arrangement that is effective on the other material web side. In the present example these are two successively located dryers 70 and 72 which blow hot air onto the non-coated side of the material web. The construction of the outside part of the drying arrangement in several parts, or individual dryers, has the advantage that installation is facilitated. The dryers can advantageously be opened for cleaning. Each part of the dryer or respectively each dryer is preferably equipped with an inlet air diffuser and an exhaust air diffuser and operates according to the recirculating air principle.

The embodiments according to FIG. 5 and 6 appear especially advantageous since on the one hand a very compact overall arrangement is achieved, and on the other hand the material web is dried immediately after coating.

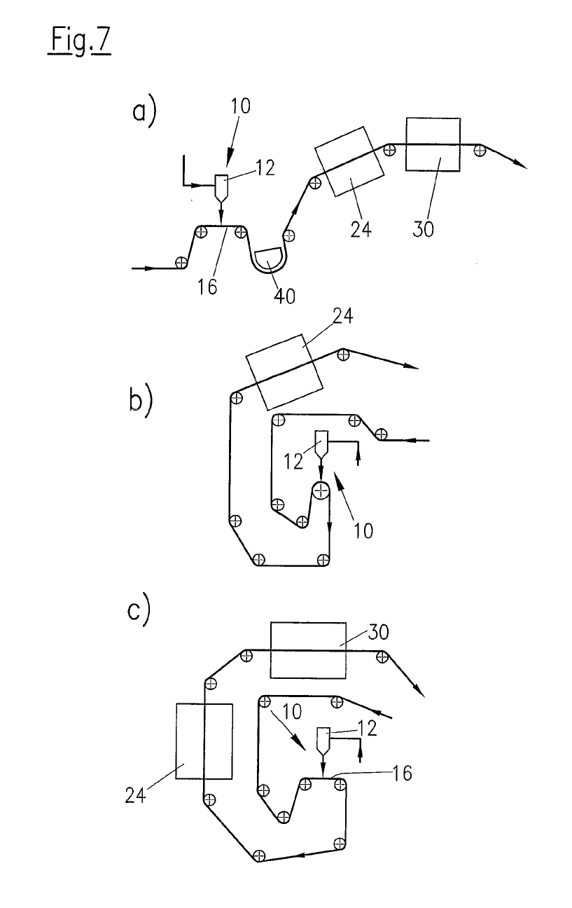

The partial details 7a, 7b and 7c in FIG. 7 illustrate typical solutions from the current state of the art for placement of the dryers after a curtain applicator device. The same identification numbers have been used as for the inventive design forms. In the case of the known solution according to 7b the coating is not applied on a material web path segment that is progressing in a straight line between to turn rollers, but onto a segment of the material web path which is being curved by a turn- and support roller, which is given consideration also in inventive machines.

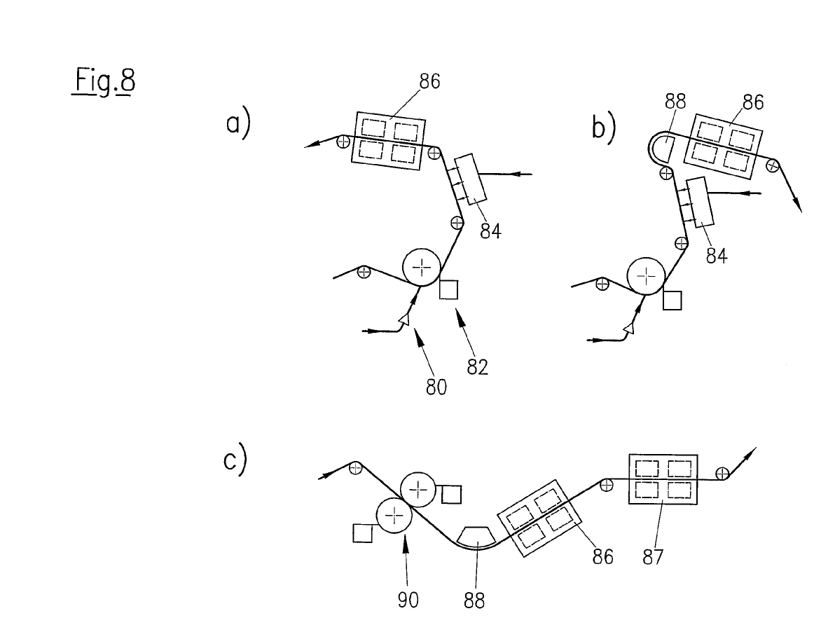

FIG. 8 illustrates typical examples of known arrangements of contact coating units with drying devices located after them. These are shown only for the sake of completeness, since little can be derived from such contact coating units due to completely different conditions for non-contact curtain coaters. FIG. 8a and FIG. 8b illustrate known solutions for blade or doctor coating units whereby excess coating is applied through an applicator device 80. In order to obtain the correct amount the excess coating medium is then removed through a doctor arrangement 82, for example by way of a blade. 84 identifies a gas-infrared dryer which is supplied with gas. 86 identifies a hot air dryer whereby in the case of FIG. 8b a turn is made by way of an air-turn 88 along the coated side in order to then complete drying in a hot air dryer 86.

FIG. 8c illustrates an example of a contact film coater arrangement 90, which applies coating on both sides of the material web. A first hot air dryer 86 is located after a turn by an air-turn 88. A second hot air dryer 87 is located after an additional turn, which in this instance is a contact turn.

For a machine with at least one curtain applicator device which applies coating onto one coating application segment of the material web it is suggested that a segment of web path which immediately follows a turning arrangement of the coating application segment which re-directs the material web in a downward direction is a drying section where the material web passes through at least one non-contact drying device which subjects the coating medium to the effects of heat. Alternatively, or in addition, it is suggested that the material web after the turn in the path and/or at the end of the coating application segment is supplied to the drying device in a drying section in such a way that the heat effect of the drying device upon the coating medium begins at a lower level relative to the coating application segment.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A machine for applying one of a liquid and paste-like coating medium onto at least one surface of a moving web of fibrous material and for drying an applied coating medium, said machine comprising:
at least one curtain applicator device configured for applying one of the liquid and paste-like coating medium onto the at least one surface of the moving web;
at least one non-contact drying device configured for drying the applied coating medium; and
a plurality of turning arrangements which are in contact with the web and which define a plurality of web segments which are at least one of offset relative to each other and progress in different directions, said plurality of turning arrangements configured such that the web passes said plurality of turning arrangements in the machine, said curtain applicator device including at least one delivery opening, said curtain applicator device delivering the coating medium from at least one delivery opening in a form of one of a single-layer and a multi-layer curtain under an influence of at least one of gravity and a plurality of other forces onto an allocated surface of the web in one coating application segment of a web path one of which progresses one of essentially horizontally and according to a radius of one of a turning roll and a support roll in said curtain applicator device and which has at least a greater moving velocity component in a horizontal direction than in a vertical direction, the web in at least one drying segment following said coating application segment in said web path passing at least one said non-contact drying device which subjects the coating medium to a heat effect in order to dry the applied coating medium at least partially, at least one of during a progression of the web and at an end of said coating application segment the web being turned around at least one turn angle of a turn by a first said turning arrangement, when provided, including a turn and support roll, so that the web in at least one first segment of said web path immediately following a redirection after said turn then one of progresses essentially vertically downward, at least initially, and has a greater moving velocity component in a vertical direction downward than prior to said turn, said first segment of said web path at least one of immediately following said turn and at said end of said coating application segment being said drying segment where the web passes through at least one said non-contact drying device which subjects the coating medium to a plurality of effects of heat.

2. The machine according to claim 1, wherein the delivery opening is one of a slot die and a slide die.

3. The machine according to claim 1, wherein the web one of in said drying segment and respectively after turning by said first turning arrangement and, in a case of an additional turn of the web in a direction of travel of the web prior to said additional turn, passes through at least one said non-contact drying device which subjects a drying medium to said plurality of effects of heat one of essentially vertically downward and with a greater moving velocity component in said vertical direction downward than prior to said turn.

4. The machine according to claim 1, wherein the web one of progresses vertically downward, at least initially, in said first segment of said web path following immediately after said first turning arrangement and has a greater moving velocity component in said vertical direction downward than in a horizontal direction.

5. The machine according to claim 1, wherein one of in said drying segment and respectively after turning by said first turning arrangement and, in a case of an additional turn in a direction of travel of the web prior to said additional turn, the web passes one of essentially vertically downward and with a greater moving velocity component in said vertical direction downward than in a horizontal direction through at least one said non-contact drying device which subjects the coating medium to said plurality of effects of heat.

6. The machine according to claim 1, wherein the web at least one of (a) one of (i) in said drying segment and (ii) respectively in said first segment of said web path immediately following after said first turning arrangement and (b) in a second segment of said web path following a second said turning arrangement passes a non-contact turning arrangement which turns the web by at least a turning angle of a turn in a manner that the web in a web outfeed area of said non-contact turning arrangement one of progresses essentially vertically in an upward direction, has a greater moving velocity component in a vertical upward direction than before said turn by said non-contact turning arrangement, and has a greater moving velocity component in said vertical upward direction than in a horizontal direction.

7. The machine according to claim 6, wherein said second turning arrangement is located adjacent to an infeed of said non-contact turning arrangement and turns the web in such a way that after said turn through said second turning arrangement the web one of initially essentially progresses vertically downward, initially has a greater moving velocity component in said vertical direction downward than before said turn by said second turning arrangement, and initially has a greater moving velocity component in said vertical direction downward than in a horizontal direction.

8. The machine according to claim 6, wherein said non-contact turning arrangement one of is a respective said non-contact drying device which subjects the coating medium to said plurality of effects of heat and at least includes a respective said non-contact drying device which subjects the coating medium to said plurality of effects of heat so that the applied coating medium can be subjected to a plurality of effects of drying during turning.

9. The machine according to claim 6, wherein the web after being turned by said non-contact turning arrangement passes through at least one said non-contact drying device, which subjects the coating medium to said plurality of effects of heat, one of essentially vertically upward, having at least a greater moving velocity component in said vertical upward direction than before said turn by said non-contact turning arrangement, and respectively having at least a greater moving velocity component in said vertically upward direction than in a horizontal direction.

10. The machine according to claim 6, wherein the web after being turned by said non-contact turning arrangement and passing through a third turning arrangement in a following third segment of said web path passes through at least one said non-contact drying device which subjects the coating medium to said plurality of effects of heat.

11. The machine according to claim 10, wherein said third turning arrangement is located adjacent to an outfeed of said non-contact turning arrangement and turns the web in such a way that after turning by said third turning arrangement the web one of progresses essentially vertically upward, has a greater moving velocity component in said vertical upward direction than before being turned by said third turning arrangement, and has a greater moving velocity component in said vertical upward direction than in a horizontal direction.

12. The machine according to claim 11, wherein one of a plurality of segments of said web path and a plurality of partial segments of said web path before and after said non-contact turning arrangement provide an essentially parallel path of the web.

13. The machine according to claim 12, wherein at least one of (a) said first turning arrangement includes one of a first turn roller and a plurality of first turn rollers by way of which the web is turned one of around a first turn angle and respectively around a plurality of turn angles in order to achieve a first complete turn angle, (b) said second turning arrangement includes one of a second turn roller and a plurality of second turn rollers by way of which the web is turned one of around a second turn angle and respectively around a plurality of turn angles in order to achieve a second complete turn angle, and (c) said third turning arrangement includes one of a third turn roller and a plurality of third turn rollers by way of which the web is turned one of around a third turn angle and respectively around a plurality of turn angles in order to achieve a third complete turn angle.

14. The machine according to claim 1, wherein the web in said web path of travel one of before and after said at least one curtain applicator device passes through at least one additional curtain applicator device which delivers the coating medium from at least one delivery opening of said additional curtain applicator device in a form of one of a single-layer curtain and a multi-layer curtain under an influence of at least one of gravity and a plurality of other forces onto one of said allocated surface and another allocated surface of the web in at least one additional coating application segment of said web path one of which progresses one of essentially horizontally and curved according to a radius of one of a turn roll and a support roll of said additional curtain applicator device and which has at least a greater moving velocity component in a horizontal direction than in a vertical direction, the web in at least one additional drying segment that is located following said additional coating application segment passing through at least one additional non-contact drying device which subjects the coating medium to said plurality of effects of heat in order to dry the applied coating medium at least partially, at least one of during a progression of the web and at an end of said additional coating application segment of the web being turned around at least one turn angle of an additional turn by an additional first turning arrangement, when provided, so that after said additional turn the web one of progresses vertically downward, at least initially, in at least one additional first segment of said web path immediately following said additional turn and has a greater moving velocity component in a vertical downward direction than prior to said additional turn.

15. The machine according to claim 14, wherein said delivery opening of said additional curtain applicator device is one of a slot die and a slide die.

16. The machine according to claim 14, wherein said additional first segment of said web path at least one of immediately after said additional turn in said web path and at said end of said additional coating application segment represents at least one said additional drying segment in which the web passes through at least one said additional non-contact drying device which subjects the coating medium to said plurality of effects of heat.

17. The machine according to claim 14, wherein at least one of after said additional turn in said web path and at said end of said additional coating application segment the web is fed to an additional non-contact drying device of said additional drying segment which subjects the coating medium to said plurality of effects of heat in such a way that a heat effect of said additional non-contact drying device upon the coating medium begins at a lower level relative to said additional coating application segment.

18. The machine according to claim 17, wherein at least one of after said additional turn in said web path and at said end of said additional coating application segment, the web one of progresses vertically downward, at least initially, in said additional first segment of said web path following immediately after another turning arrangement and has a greater moving velocity component in said vertical downward direction than in a horizontal direction.

19. The machine according to claim 17, wherein at least one of after said additional turn in said web path and at said end of said additional coating application segment, one of in said additional drying segment and respectively in said additional first segment, the web one of progresses vertically downward, at least initially, in said additional first segment of said web path following immediately after another turning arrangement and has a greater moving velocity component in said vertical downward direction than in a horizontal direction.

20. The machine according to claim 17, wherein at least one of after said additional turn in said web path and at said end of said additional coating application segment, one of in said additional drying segment and respectively in said additional first segment, and at least one of in an additional second segment following said additional first segment and in an additional third segment in said web path, the web one of progresses vertically downward, at least initially, in said additional first segment of said web path following immediately after another turning arrangement and has a greater moving velocity component in said vertical downward direction than in a horizontal direction.

21. The machine according to claim 17, wherein one of a plurality of segments of said web path and a plurality of partial segments of said web path after said coating application segment and after said additional coating application segment provide a plurality of moving velocity components of the web in opposite horizontal directions relative to each other.

22. The machine according to claim 21, wherein one of a plurality of segments of said web path and a plurality of partial segments of said web path after said coating application segment and after said additional coating application segment provide an essentially parallel path of the web with said plurality of moving velocity components of the web in said opposite horizontal directions relative to each other.

23. A machine for applying one of a liquid and paste-like coating medium onto at least one surface of a moving web of fibrous material and for drying an applied coating medium, said machine comprising:
at least one curtain applicator device configured for applying one of the liquid and paste-like coating medium onto the at least one surface of the moving web;
at least one non-contact drying device configured for drying the applied coating medium; and
a plurality of turning arrangements which are in contact with the web and which define a plurality of web segments which are at least one of offset relative to each other and define a plurality of segments in a web path progressing in different directions, said plurality of turning arrangements configured such that the web passes said plurality of turning arrangements in the machine, said curtain applicator device including at least one delivery opening, said curtain applicator device delivering the coating medium from at least one delivery opening in a form of one of a single-layer and a multi-layer curtain under an influence of at least one of gravity and a plurality of other forces onto an allocated surface of the web in one coating application segment of said web path one of which progresses one of essentially horizontally and according to a radius of one of a turning roll and a support roll in said curtain applicator device and which has at least a greater moving velocity component in a horizontal direction than in a vertical direction, the web in at least one drying segment following said coating application segment in said web path passing at least one said non-contact drying device which subjects the coating medium to a heat effect in order to dry the applied coating medium at least partially, at least one of during a progression of the web and at an end of said coating application segment the web being turned around at least one turn angle of a turn by a first said turning arrangement, when provided, including a turn and support roll, so that the web in at least one first segment of said web path immediately following a redirection after said turn then one of progresses essentially vertically downward, at least initially, and has a greater moving velocity component in a vertical direction downward than prior to said turn, at least one of after turning said web path and at said end of said coating application segment the web being supplied to at least one said non-contact drying device of at least one drying section of the machine which subjects the coating medium to an effect of heat in such a way that said heat effect of at least one said non-contact drying device upon the coating medium begins at a lower level relative to said coating application segment.

24. The machine according to claim 23, wherein said first segment of said web path at least one of immediately following said turn and at said end of said coating application segment being said drying segment where the web passes through at least one said non-contact drying device which subjects the coating medium to a plurality of effects of heat.

25. The machine according to claim 23, wherein the delivery opening is one of a slot die and a slide die.
